(19) United States
(12) Patent Application Publication
(10) Pub. No.: US 2009/0246986 A1
(43) Pub. Date: Oct. 1, 2009

(54) Connector

(75) Inventors: Zhong-Ming Zhang, Taoyuan Hsien (TW); Yu-Yuan Tai, Taoyuan Hsien (TW)

Correspondence Address: REED SMITH LLP, Suite 1400, 3110 Fairview Park Drive, Falls Church, VA, 22042, US

(73) Assignee: Delta Electronics, Inc.

(21) Appl. No.: 12/219,436

(22) Filed: Jul. 22, 2008

(30) Foreign Application Priority Data
Mar. 31, 2008 (TW) 097111610

(51) Int. Cl. H01R 24/00

(52) U.S. Cl. 439/76.1; 439/676

(57) ABSTRACT

The invention discloses a connector including a body and a circuit board. The body includes an accommodating space and a casing. The circuit board is disposed in the accommodating space. There is a grounding circuit area disposed on part of the circuit board. Part of the circuit board extrudes out of the casing. The casing is electrically connected to the grounding circuit area.

### CROSS REFERENCE TO RELATED APPLICATIONS

This Non-provisional application claims priority under 35 U.S.C. §119(a) on Patent Application No(s). 097111610 filed in Taiwan, Republic of China on Mar. 31, 2008, the entire contents of which are hereby incorporated by reference.

### BACKGROUND OF THE INVENTION

1. Field of the Invention

This present invention relates to a connector and, in particular, to a connector having a second base which clasps pins effectively and firmly.

2. Description of the Prior Art

Conventional grounding methods of integrated RJ-45 connectors are usually adopted the following two ways. One way is to connect a signal pin of physical layer with a high voltage capacitor, so as to accomplish the purpose of grounding through the signal pin. The other is to connect a steel casing with a high voltage capacitor, so as to accomplish the purpose of grounding through the grounding pins of the steel casing.

Wherein the way of connecting the high voltage capacitor and the steel casing is to solder the circuit board wrapped in the RJ-45 connector to the steel casing through wires or pins of the capacitor, wiring from the circuit board or pins soldered to the steel casing, so as to accomplish the purpose of grounding. However, both the above ways need additional components and processes to connect the steel casing and the circuit board, and therefore, both the production cost and the production time increase substantially. In addition, there exists a technique of soldering a clip on the inner wall of the steel casing; nevertheless, the technique is to elastically clip the circuit board by the clip, so the problem of failed contact occurs easily. If the above mentioned clip needs to be soldered on the circuit board after clipping the circuit board, it is difficult in manufacturing because the solder point is hidden by the steel casing or the circuit board.

In addition, when signal pins are inserted into the plastic base of the RJ45 connector, there some cracks on the plastic base occur so that the signal pins cannot be held firmly on the plastic base, thereby leading to the deformation or breaking of the base.

### SUMMARY OF THE INVENTION

In view of foregoing, the invention provides a connector and a part of a circuit board therein extrudes out of a casing, so that a grounding circuit area on the circuit board could easily be connected electrically to the casing so as to simplify the process and enhance the stability and convenience of the soldering.

To achieve the above, the connector of the invention includes a body and a circuit board. The body includes an accommodating space and a casing. The circuit board is disposed in the accommodating space, and has a grounding circuit area formed on a part of the circuit board. The part of the circuit board extrudes out of the casing. The casing comprises a through hole for passing the circuit board therethrough to extrude out of the casing. The casing could be a metal casing electrically connected to the grounding circuit area. Because the circuit board extrudes out of the casing, i.e. the grounding circuit area of the circuit board is exposed out of the casing after assembling the connector, an operator or an operation machine could connect the metal casing and the grounding circuit area easily and accurately so as to accomplish the purpose of grounding. The connector of the present invention can not only substantially reduce the steps and the difficulty of conventional grounding operation, but also increase the stability of the grounding operation and the product yield rate.

In addition, pins of the connector of the present invention could be inserted into the body firmly without causing cracks on the body, and prevent from loosing or tilting. In other words, the body further includes a second base and at least one pin. The second base includes a first recess and at least one second recess, such that the body could be an N-shaped structure, a Z-shaped structure, an S-shaped structure, an F-shaped structure, or a 2-shaped structure. There is at least one through hole formed in the inner wall of the first recess. The pins are inserted into the through hole and clasped by the through holes.

The pins are also electrically connected to the circuit board. The through hole could be a funnel-shaped hole or a hole with various diameters. The profile of the through hole has a property of guiding the pins correctly when inserting. The first recess provides a space for the deformation of the inner wall when inserting, so as to prevent from the damage of the material around the through hole for sustaining overloaded stress, thus the through holes still clasp the pins firmly.

Furthermore, the connector of the present invention further includes at least one electronic component disposed in the second recess. The electronic component is electrically connected to the circuit board. The electronic component could be an inductor, a resistor, a capacitor, a transformer, or other electronic components. Moreover, the wires of the electronic component disposed in the second recess of the second base could be arranged directly to the pins inserted, thereby reducing both the difficulty of soldering the electronic component directly on the circuit board and the product defect ratio after assembling, and also making the signal paths from the pins to the electronic component (such as filter coil) as equal as possible, so as to raise the electromagnetic compatibility.

The connector of the present invention comes with a design to simplify the assembly process. The casing of the connector could interlock quickly with the same material based on the design. Not only it improves the smoothness of the casing, but also reduces the physical connections between components to increase the product stability. For this feature, the casing of the connector includes at least one first extension having at least one protrusion and at least one second extension having at least one hole. The protrusion and the hole could be detachably engaged correspondingly. Alternatively, the casing of the connector includes at least one first extension and at least one second extension. The first extension and the second extension include corresponding butterfly-lock structures. The above feature could be achieved by engaging the first extension and the second extension correspondingly.

It is added that the connector of the present invention could be an RJ45 connector, an RJ-11 connector or a USB connector. For example, the connector of the present invention further includes a connection terminal disposed in the accommodating space for connecting with an RJ-45 connector, an RJ-11 connector or a USB connector.

### BRIEF DESCRIPTION OF THE APPENDED DRAWINGS

The present invention will become more fully understood from the subsequent detailed description and accompanying drawings, which are given by way of illustration only, and thus are not limitative of the present invention, and wherein:

FIG. 1 is a schematic diagram of a connector according to a preferred embodiment of the present invention.

FIG. 2 is a perspective sectional view of the connector shown in FIG. 1.

FIG. 3 is a partially enlarged sectional view of the second base of the connector shown in FIG. 2.

FIG. 4 is a bottom view of the connector shown in FIG. 1.

### DETAILED DESCRIPTION OF THE INVENTION

The present invention will be apparent from the following detailed description, which proceeds with reference to the accompanying drawings, wherein the same references relate to the same elements.

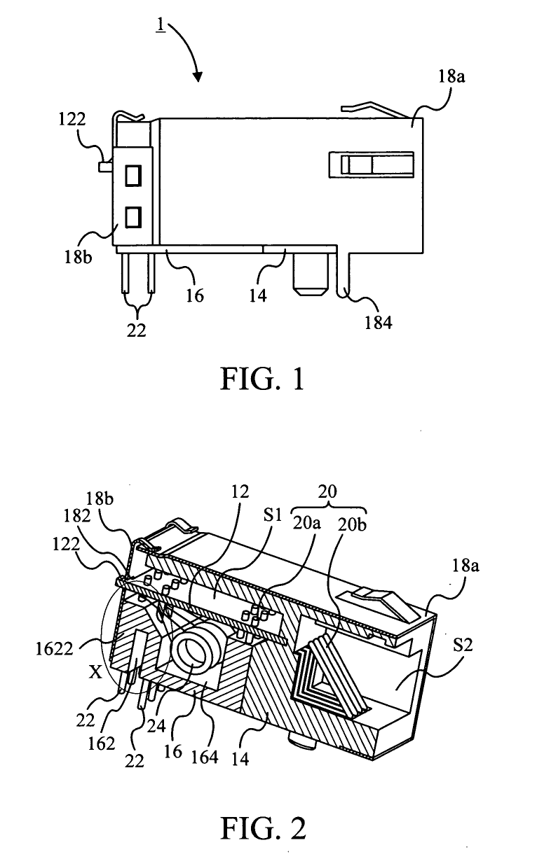

A connector 1 of the present invention is shown in FIG. 1 and FIG. 2 according to a preferred embodiment. FIG. 2 is a perspective sectional view of the connector 1 of the present invention. The connector 1 includes a body and a circuit board 12. The body includes a casing and a base. The casing includes a main cover 18a and a rear cover 18b, and the casing could be a metal casing. The casing encapsulates the base. The base could be divided into a first base 14 and a second base 16. The first base 14 includes an accommodating space S2 served as a connection port. An accommodating space S1 is formed between the first base 14, the second base 16, and the casing. The connector 1 could be an RJ-45 connector, an RJ-11 connector or a USB connector.

Furthermore, the rear cover 18b is connected to the main cover 18a via a rear end of the main cover 18a by buckling. The connector 1 of the invention further includes a connection terminal 20 disposed both in the accommodating spaces S1 and S2. One end 20a of the connection terminal 20 disposed in the accommodating space S1 is electrically connected to the circuit board 12, and the other end 20b of the connection terminal 20 disposed in the accommodating space S2 is electrically connected to an external plug. The external connector could be an RJ-45 connector, an RJ-11 connector or a USB connector.

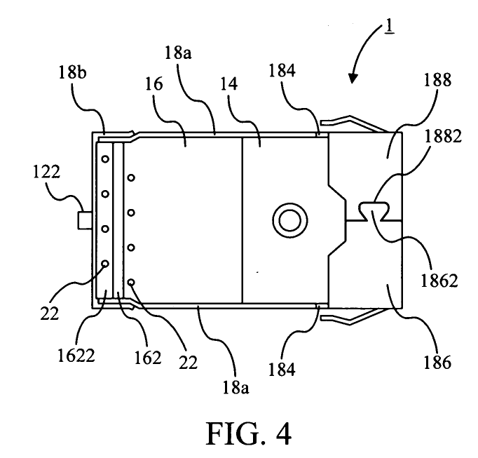

Furthermore, the rear cover 18b includes a through hole 182. A grounding circuit area 122 is formed on a part of the circuit board 12, and said circuit board 12 passes through the through hole 182 such that the grounding circuit area 122 extrudes out of the rear cover 18b. An operator or an operation machine could electrically connect the rear cover 18b and the grounding circuit area 122 by soldering or other methods easily. In this case, said circuit board 12 could be grounded via the grounding circuit area 122 and the casing. In the embodiment shown in FIG. 4, the circuit board 12 is grounded by connecting pins 184 of the main cover 18a to an external circuit board.

As shown in FIG. 2, the second base 16 includes a first recess 162 and a second recess 164. There are several pins 22 inserted into the side wall 1622 of the first recess 162. The second recess 164 accommodates several electronic components 24, such as inductors, resistors, capacitors, transformers or other electronic components. The pin 22 has one end electrically connected to the circuit board 12, and the other end connected with an external electrical element. Because the pins 22 are inserted directly into the second base 16, the wires of the electronic components 24 disposed in the second recess 164 could be led directly to the pins 22. Thereby, it could not only reduce both the difficulty of soldering the electronic components 24 directly on the circuit board 12 and the defective ratio due to the following assembly, but also make the signal paths from the pins 22 to the electronic components 24 (such as a filter coil) equal, so as to raise the electromagnetic compatibility.

In addition, because the electronic components 24, such as coil, have been disposed and mounted in the second recess 164 in advance, the circuit board 12 could be inserted with both the pins 22 and the end 20a of the connection terminal 20 directly so as to prevent from loosing or failed contacts of the electronic components 24 and the circuit board 12. The design of the connector 1 of the invention is conducive to both the stability of the manufacture and the raise of yield rate.

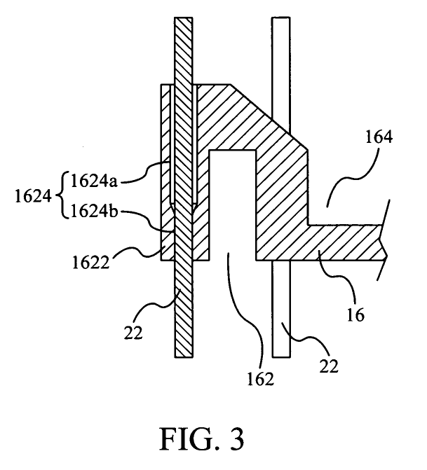

Please refer to FIG. 3 showing an enlarged partial diagram of the area X in FIG. 2, therein, the electronic components 24 disposed in the second recess 164 are omitted. There are through holes 1624 formed in the side wall 1622 of the first recess 162. The through hole 1624 is substantially funnel-shaped hole, and it includes a first portion 1624a with a larger diameter and a second portion 1624b with a smaller diameter. When the pin 22 is inserted into the through hole 1624, the first portion 1624a has a function of guidance and tolerating larger inaccuracy so that the pin 22 is inserted into the through hole 1624 accurately and is clasped by the second portion 1624b. Because of the design of a first recess 162 formed alongside the side wall 1622, when the fin 22 is inserted into the through hole 1624, stress deforms the side wall 1622. However, because the first recess 162 is provided as a deformable space, the side wall 1622 would not be damaged by the overloaded stress, thereby preventing from cracking around the through hole 1624 and the pin 22 could be tightly and un-loosely mounted in the through hole 1624. It is added that, in the embodiment, the direction of the opening of the first recess 162 is opposite to that of the second recess 164. However, based on the function of the above first recess 162, the direction of the opening of the first recess 162 is the same as that of the second recess 164, such as toward the interior of the connector 1. The second base 16 of the connector 1 could be formed to be an N-shaped structure, a Z-shaped structure, an S-shaped structure or an F-shaped structure.

The connector 1 of the invention has a design which simplifies the assembly process. The casing of the connector 1 could interlock quickly through itself material. It not only increases the smoothness of the appearance of the product but also reduces the physical connections between components to increase the product stability. Please refer to FIG. 4 showing a bottom view of the connector of FIG. 1. The main cover 18a of the connector 1 includes a first extension 186 and a second extension 188. The first extension 186 includes a protrusion 1862; the second extension 188 includes a hole 1882 correspondingly. The protrusion 1862 and the hole 1882 are detachably engaged correspondingly. As shown in FIG. 4, after the protrusion 1862 and the hole 1882 are engaged, the first extension 186 is connected to the second extension 188 to form a smooth surface for being connected with other elements easily. In addition, the protrusion 1862 and the hole 1882, for example, could be complementary butterfly-like engagement. Furthermore, said connection could also be applied to the main cover 18a and the rear cover 18b.

Although the present invention has been described with reference to specific embodiments, this description is not meant to be construed in a limiting sense. Various modifications of the disclosed embodiments, as well as alternative embodiments, will be apparent to persons skilled in the art. It is, therefore, comtemplated that the appended claims will cover all modifications that fall within the true scope of the present invention.

What is claimed is:

1. A connector comprising:
a body comprising an accommodating space and a casing; and
a circuit board disposed in the accommodating space, and having a grounding circuit area disposed on a part of the circuit board extruding out of the casing.

2. The connector of claim 1, wherein the casing comprises a through hole for passing the circuit board therethrough.

3. The connector of claim 1, wherein the body further comprises a first base and a second base, the second seat comprises a first recess and at least one second recess, and at least one through hole is formed in a side wall of the first recess.

4. The connector of claim 3, further comprising at least one pin inserted into the through hole and clasped by the through hole.

5. The connector of claim 4, wherein the pin has one end electrically connected with the circuit board, and the other end connected with an external electrical element.

6. The connector of claim 3, wherein the through hole is a funnel-shaped hole or a hole with various diameters.

7. The connector of claim 3, further comprising at least one electronic component disposed in the second recess.

8. The connector of claim 7, wherein the electronic component is an inductor, a resistor, a capacitor, or a transformer.

9. The connector of claim 7, wherein the circuit board is electrically connected with the electronic component.

10. The connector of claim 3, wherein the second base is an N-shaped structure, a Z-shaped structure, an S-shaped structure or an F-shaped structure.

11. The connector of claim 3, wherein the first base comprises an another accommodating space served as a connection port.

12. The connector of claim 3, wherein a direction of an opening of the first recess is opposite to that of the second recess.

13. The connector of claim 3, wherein a direction of an opening of the first recess is the same as that of the second recess.

14. The connector of claim 1, wherein the casing is a metal casing electrically connected to the grounding circuit area.

15. The connector of claim 1, wherein the casing comprises at least one first extension and at least one second extension, the first extension comprises at least one protrusion, the second extension comprises at least one hole, and the protrusion and the hole are detachably engaged correspondingly.

16. The connector of claim 1, wherein the casing comprises at least one first extension and at least one second extension, and the first extension and the second extension comprise corresponding butterfly-like engagements.

17. The connector of claim 1, being an RJ-45 connector, an RJ-11 connector or a USB connector.

18. The connector of claim 1, wherein the casing comprises a main cover and a rear cover, and the rear cover is buckled to a rear end of the main cover.

19. The connector of claim 1, wherein the circuit board is grounded through a grounding pin of the casing connected to an external circuit board.

20. The connector of claim 1, further comprising a connection terminal disposed in the accommodating space, wherein the connection terminal has one end electrically connected to the circuit board, and the other end electrically connected to an external plug.
